(19) United States
(12) Patent Application Publication
(10) Pub. No.: US 2024/0322511 A1
(43) Pub. Date: Sep. 26, 2024

(54) CONNECTOR, CONNECTOR MANUFACTURING APPARATUS, AND CONNECTOR MANUFACTURING METHOD

(71) Applicant: Yazaki Corporation, Tokyo (JP)

(72) Inventors: Masayuki SAITO, Shizuoka (JP); Hiromasa KUBOTA, Shizuoka (JP)

(73) Assignee: Yazaki Corporation, Tokyo (JP)

(21) Appl. No.: 18/609,665

(22) Filed: Mar. 19, 2024

(30) Foreign Application Priority Data
Mar. 20, 2023 (JP) 2023-044220

(51) Int. Cl. H01R 43/18; H01R 13/506

(52) U.S. Cl. CPC H01R 43/18; H01R 13/506

(57) ABSTRACT

A connector includes a housing fitting to an accommodation portion of a jig having the accommodation and a positioning rib. A side retainer being displaceable to a regular retaining position and a temporarily retaining position is provided in the housing. A guide surface being slidingly contactable with the positioning rib in a state of being at the regular retaining position is provided in the side retainer. The guide surface is positioned at further lower side with respect to the positioning rib as the side retainer is positioned at further front side. In a state in which the fitting of the housing has been completed, the side retainer is positioned at the temporarily retaining position while being sandwiched in the height direction by the positioning rib and an inner wall surface of the accommodation portion so as to restrict a displacement to the height direction.

### TECHNICAL FIELD

The present invention relates to a connector, a connector manufacturing apparatus, and a connector manufacturing method.

### BACKGROUND ART

Conventionally, a connector in which a position of a retainer as a retaining member is changeable by a jig is known (for example, see Patent Document 1). According to the connector recited in Patent Document 1, a box-shaped retainer is inserted from an up-down direction into a housing in which a terminal is inserted in a front-rear direction. The retainer is displaceable between a temporarily retaining position where the terminal is insertable and a regular retaining position for retaining the inserted terminal in the up-down direction. In a central portion of the housing, a retaining jig-insertion hole extending in the front-rear direction is formed. A rod-shaped retainer operation jig having a jig side-tapered portion at a front end thereof is inserted into the retaining jig-insertion hole. The jig side-tapered portion of the retainer operation jig that is inserted into the retaining jig-insertion hole is configured to displace the retainer at the regular retaining position to the temporarily retaining position by being in sliding contact with a retainer side-tapered portion formed in the retainer.

### CITATION LIST

### Patent Documents

[Patent Document 1] JP 2007-188783A

### SUMMARY OF THE INVENTION

### Technical Problem

However, the above-described retainer operation jig is a rod-shaped tool extending in the insertion direction of the terminal. Also, at the time of the displacement of the retainer, it is necessary to insert this tool inside the retaining jig-insertion hole and make the jig side-tapered portion and the retainer side-tapered portion to be in correct sliding contact with each other in a state difficult to observe visually. Accordingly, the accuracy of the operation varies depending on the skill level of an operator who performs the displacement of the retainer, and it is difficult to make the retainer to be displaced to the temporarily retaining position correctly. Also, due to the configuration of displacing the box-shaped retainer by the rod-shaped tool, it is possible that a force applied to the retainer is biased such that a posture of the retainer during the displacement becomes unstable. Accordingly, it is difficult to make the retainer to be displaced to the temporarily retaining position correctly. Also, in a state in which the retainer has been displaced to the temporarily retaining position, in a case in which the tool has been removed from the retaining jig insertion hole, there is a situation in which the retainer positioned at the temporarily retaining position is unintentionally displaced to the regular retaining position at the time of transporting the connector or the like. Accordingly, it is difficult to maintain the state in which the terminal can be correctly inserted into the housing.

An object of the present invention is to achieve a connector, a connector manufacturing apparatus, and a connector manufacturing method for stably maintaining a state in which the terminal is correctly inserted into the housing.

### Solution to Problem

In order to solve the above-mentioned technical problem, a connector comprises a housing fitting to an accommodation portion of a connector manufacturing apparatus, wherein the connector manufacturing apparatus includes the accommodation portion opening at one side in a predetermined direction, and a positioning rib that protrudes inwardly in a width direction intersecting with the predetermined direction and extends in the predetermined direction inside the accommodation portion, a retaining member is provided in the housing to be displaceable to a regular retaining position at one side in a height direction intersecting with the predetermined direction and the width direction and a temporarily retaining position at the other side in the height direction, a guide surface provided in the retaining member to be slidingly contactable with the positioning rib in a state in which the retaining member is at the regular retaining position, the guide surface being in slidingly contact with the positioning rib is positioned further at the other side of the height direction with respect to the positioning rib as the retaining member is positioned further at the other side of the predetermined direction, and in a state in which the fitting of the housing to the accommodation portion has been completed, the retaining member is positioned at the temporarily retaining position while the retaining member is sandwiched by the positioning rib and an inner wall surface of the accommodation portion in the height direction so as to restrict a displacement to the height direction.

Also, a connector manufacturing apparatus comprises an accommodation portion that opens at one side of a predetermined direction intersecting with a height direction so as to cause a housing having a retaining member being displaceable to a regular retaining position at one side of the height direction and a temporarily retaining position at the other side of the height direction to be fitted thereto, wherein a positioning rib protruding inwardly in a width direction interesting with the predetermined direction and extend in the predetermined direction is provided in the accommodation portion, the positioning rib is slidingly contactable with a guide surface provided in the retaining member in a case in which the retaining member is at the regular retaining position, the positioning rib being in slidingly contact with the guide surface is positioned at further the one side of the height direction with respect to the guide surface as the retaining member is positioned at further the other side of the predetermined direction, and in a state in which the fitting of the housing to the accommodation portion has been completed, the positioning rib and an inner wall surface of the accommodation portion sandwiches the retaining member positioned at the temporarily retaining position therebetween in the height direction so as to restrict the retaining member from displacing to one side of the height direction.

Furthermore, a connector manufacturing method for manufacturing a connector using the connector manufacturing apparatus described above, comprises a preparation step of making the housing to be opposite with respect to the accommodation portion in the predetermined direction; a fitting step, subsequent to the preparation step, of fitting the housing to the accommodation portion to position the retaining member at the temporarily retaining position and sandwich the retaining member at the height direction by the positioning rib and an inner wall surface of the accommodation portion so as to restrict a displacement to the height direction; and an insertion step, subsequent to the fitting step, of inserting a terminal into the housing, wherein in a case in which the retaining member is at the regular retaining position during the preparation step, in the fitting step, as the retaining member displaces to the other side of the predetermined direction, the guide surface is displaced to the temporarily retaining position while being in slidingly contact with the positioning rib.

### Effect of the Invention

According to the present invention, it is possible to achieve a connector, a connector manufacturing apparatus, and a connector manufacturing method for stably maintaining a state in which the terminal is correctly inserted into the housing.

### BRIEF DESCRIPTION OF THE DRAWINGS

FIG. 1 is a perspective view showing a connector according to an embodiment of the present invention.

FIG. 2 is an exploded perspective view showing a housing and a front retainer configuring part of the housing.

FIG. 3 is an exploded perspective view showing the housing and a side retainer configuring part of the housing.

FIG. 4 is a perspective view showing a jig accommodating the housing.

FIG. 5 is a rear view showing the housing in a state of being accommodated in the jig when viewed from a rear side.

FIG. 6 is a cross-sectional view showing the housing during an operation of fitting the housing to the jig with the side retainer positioned at the regular retaining position, which is taken at a position along the line A-A in FIG. 5.

FIG. 7 is a cross-sectional view showing the housing in a state in which the insertion into the jig is completed, which is taken at the position along the line A-A in FIG. 5.

FIG. 8A is a cross-sectional view showing the housing during the operation of fitting the housing to the jig with the side retainer positioned at the regular retaining position, which is taken at a position along the line B-B in FIG. 5.

FIG. 8B is a cross-sectional view showing the housing in a state in which the insertion into the jig is completed, which is taken at the position along the line B-B in FIG. 5.

FIG. 9 is an enlarged view showing a main portion in FIG. 8B.

FIG. 10A is a cross-sectional view showing the housing during the operation of fitting the housing to the jig with the side retainer positioned at a temporarily retaining position, which is taken at a position along the line A-A in FIG. 5.

FIG. 10B is a cross-sectional view showing the housing in the state in which the insertion into the jig is completed, which is taken at the position along the line A-A in FIG. 5.

FIG. 11A is a cross-sectional view showing the housing during the operation of fitting the housing to the jig with the side retainer positioned at the temporarily retaining position, which is taken at a position along the line B-B in FIG. 5.

FIG. 11B is a cross-sectional view showing the housing in a state in which the insertion into the jig is completed, which is taken at the position along the line B-B in FIG. 5.

### DESCRIPTION OF EMBODIMENTS

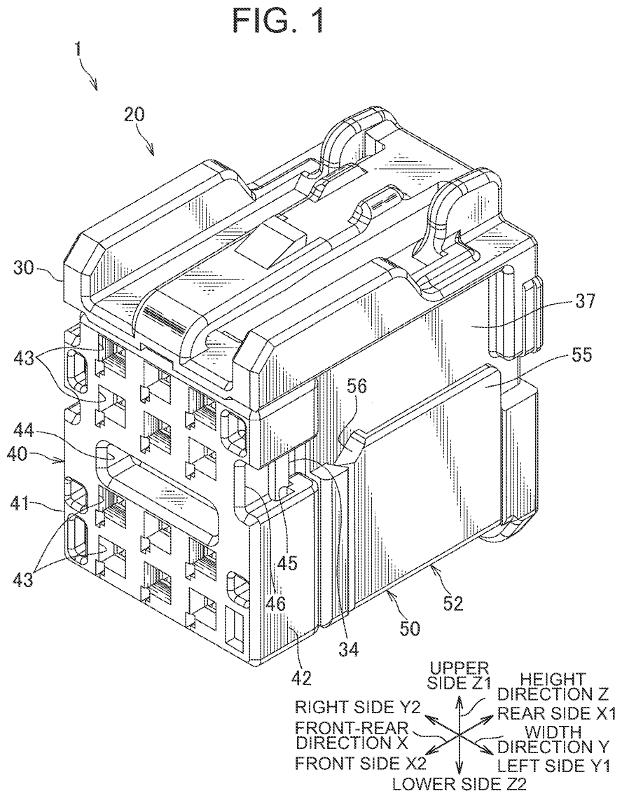

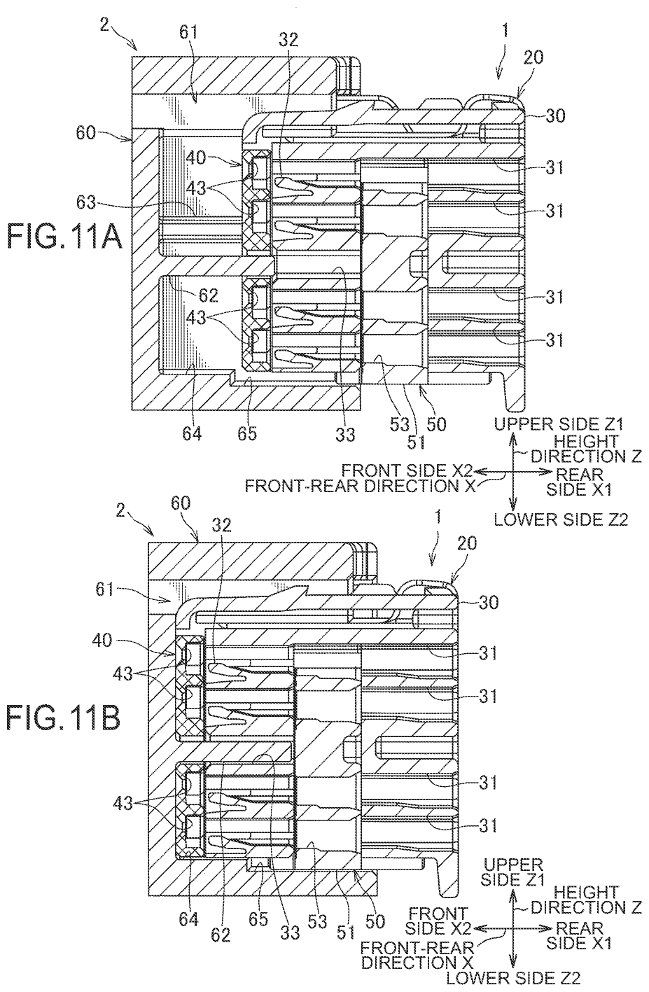

Hereinafter, an embodiment of a connector 1, a jig 2 as a connector manufacturing apparatus, and a connector manufacturing method will be described based on FIG. 1 to FIG. 11B. According to the present embodiment, in the figures, an arrow X, an arrow Y, and an arrow Z are directions perpendicular to each other. The arrow X indicates a predetermined direction in which the connector 1 and the jig 2 face each other. According to the preset embodiment, this predetermined direction is recorded as a “front-rear direction X”, wherein one side in the front-rear direction X is recorded as a “rear side X1”, and the other side is recorded as a “front side X2”. The arrow Y indicates a width direction of the connector 1 and the jig 2. The width direction is recorded as a “width direction Y”, wherein one side in the width direction Y is recorded as a “left side Y1”, and the other side is recorded as a “right-side Y2”. The arrow Z indicates a height direction of the connector 1 and the jig 2. The height direction is recorded as a “height direction Z”, wherein one side in the height direction Z is recorded as an “upper side Z1”, and the other side is recorded as a “lower side Z2”. The definitions of these directions are only for facilitating the description, and they are not used for limiting the directions of the connector 1 and the jig 2 in an actual usage state.

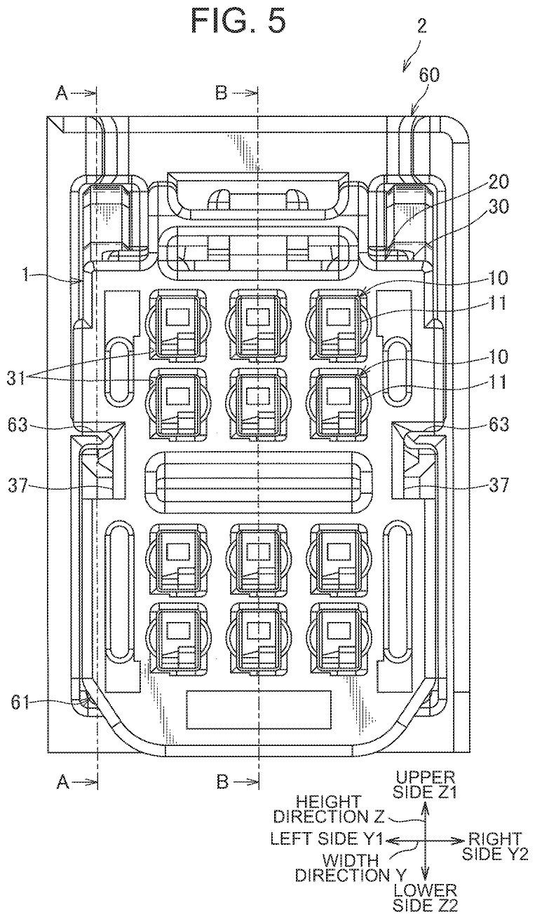

FIG. 1 is a perspective view showing the connector 1. The connector 1 is, for example, a female connector configuring part of a wire harness for connecting an apparatus mounted in a hybrid vehicle such as an inverter or the like and a power source. The connector 1 includes an electric wire with terminal 10 (see FIG. 5) and a housing 20 for accommodating a female terminal (terminal) 11 of the electric wire with terminal 10. The electric wire with terminal 10 is a shielded wire configured of an electric wire that is not shown in figures and the female terminal 11 connected to the electric wire, and according to the present embodiment, as shown in FIG. 5, there are totally twelve of electric wires with terminal 10 prepared wherein three thereof are arranged side by side in the width direction Y and four thereof are arranged side by side in the height direction Z. As shown in FIG. 1, the housing 20 includes a box-shaped main body portion 30, a front retainer 40 attached to a front-end portion of the main body portion 30, and a side retainer (retaining member) 50 attached to the main body portion 30 to cover two side walls in the width direction Y and a lower wall of the main body portion 30.

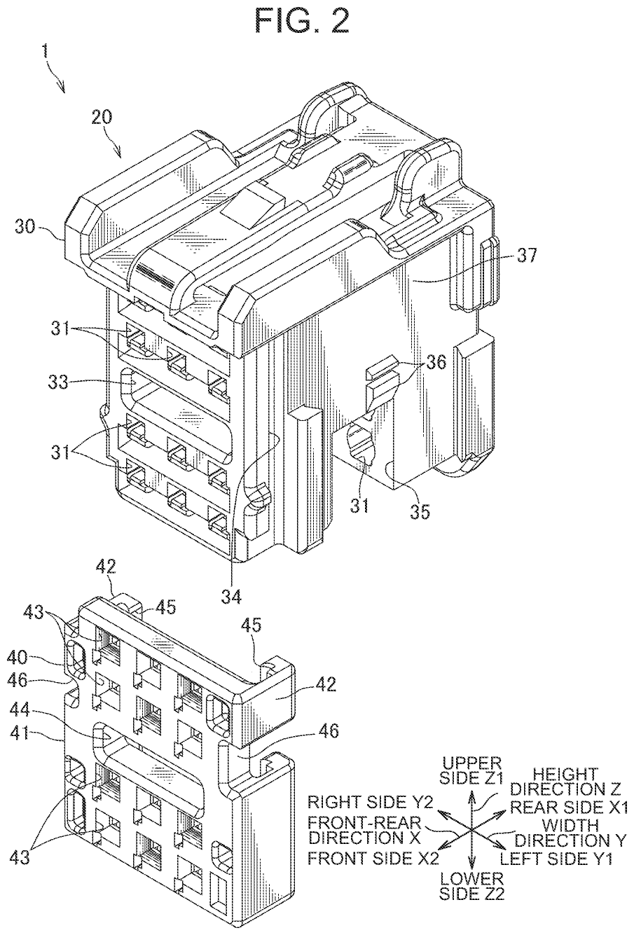

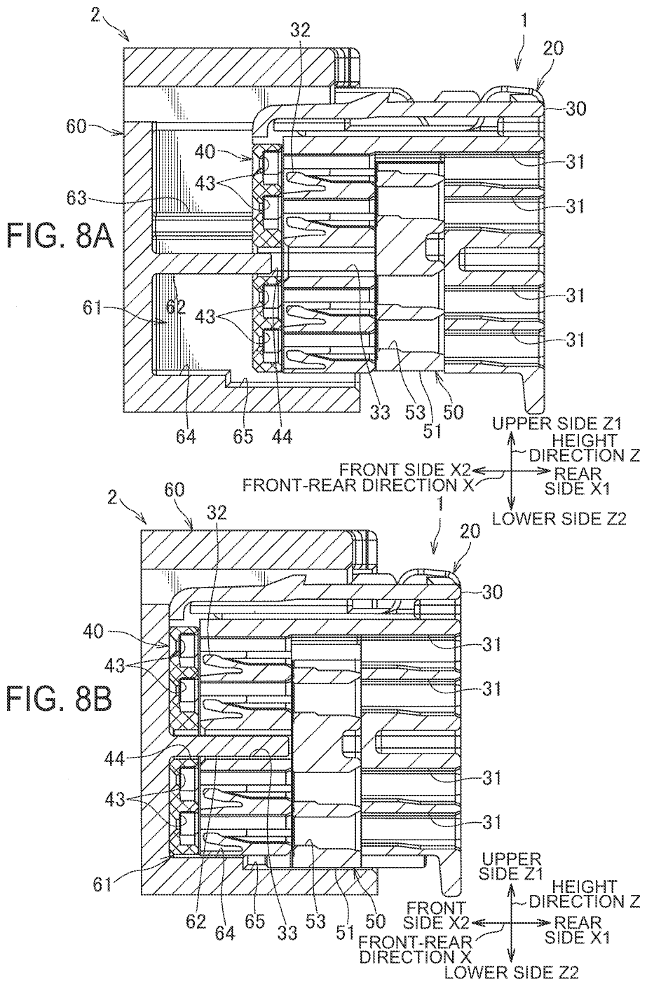

As shown in FIG. 2, the main body portion 30 is formed in a substantially rectangular box shape using a resin material. Inside the main body portion 30, a terminal accommodation room 31 penetrating in the front-rear direction X is formed. The terminal accommodation room 31 is a portion for accommodating the female terminal 11 that is inserted from the rear side X1 toward the front side X2, and there are totally twelve of terminal accommodation rooms 31 formed wherein four thereof are arranged side by side in the width direction Y and three thereof are arranged side by side in the height direction Z, corresponding to the number of the female terminals 11 in the present embodiment. Inside the terminal accommodation room 31, a lance 32 (see FIG. 8A and the like) stands up diagonally from the wall portion at the lower side Z2 toward the front side X2 is formed, and the lance 32 is configured to retain the female terminal 11 such that a slipping of the female terminal 11 in the front-rear direction X is prevent. As shown in FIG. 2, inside the main body portion 30, a positioning hole 33 penetrating in the front-rear direction X is formed between a portion where two segments of terminal accommodation rooms 31 at the upper side Z1 are formed and a portion where two segments of terminal accommodation rooms 31 at the lower side Z2 are formed. The positioning hole 33 is a portion into which a restricting protrusion 62 of the jig 2 described below is inserted, and the positioning hole 33 together with the restricting protrusion 62 determine a position in the width direction Y and the height direction Z of the housing 20 inside the jig 2.

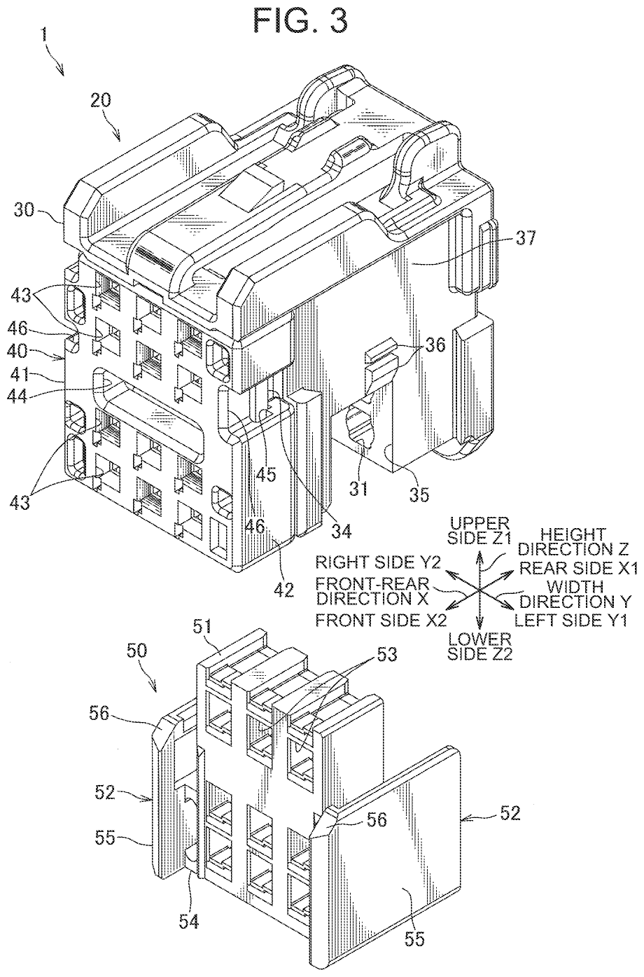

A guide groove 34 being concave inwardly in the width direction Y and extending in the height direction Z is formed in each of portions at the front side X2 in the side wall at the left side Y1 of the main body portion 30 and in the side wall at the right side Y2 of the main body portion 30. This guide groove 34 is a portion configured to guide the front retainer 40 such that the front retainer 40 moves along the height direction Z as an attachment direction thereof at the time of attaching the front retainer 40, and the guide groove 34 opens at the lower side Z2. In the portion at the lower side Z2 of the main body portion 30, an attachment portion 35 that is cut off in a rectangular shape is formed so as to open at the lower side Z2 and in the width direction Y. The attachment portion 35 is a portion for attaching the side retainer 50, as shown in FIG. 3, and the attachment portion 35 communicates with the inside of the main body portion 30. In the both side walls in the width direction Y of the main body portion 30, in the portion at the upper side Z1 of the attachment portion 35, a retaining protrusion 36 for retaining the side retainer 50 is formed.

The retaining protrusion 36 is a protrusion for retaining the side retainer 50 to the main body portion 30, and the retaining protrusion 36 is configured to retain a retained portion of the side retainer 50 that is not shown in figures. At the upper side Z1 of the retaining protrusion 36, a fitting concave portion 37 being concave inwardly in the width direction Y is formed. The fitting concave portion 37 is a concave portion to receive a positioning rib 63 described below inside an accommodation portion 61 of the jig 2 described below. The fitting concave portion 37 is configured to have a boundary of the upper wall and the side wall of the main body portion 30 as an upper end thereof, and a predetermined width in the height direction Z. The predetermined width refers to a width larger than the width of the positioning rib 63 in the height direction Z.

The front retainer 40 is a member configured to perform the prevention of slipping of the female terminal 11 that is attached to the front-end portion of the main body portion 30 and the like. The front retainer 40 configures the front wall of the housing 20 that is attached to the front-end portion of the main body portion 30. As shown in FIG. 2, the front retainer 40 includes a front wall 41 in a rectangular plate shape extending in the width direction Y and the height direction Z, and side walls 42 protruding toward the rear side X1 from two end portions in the width direction Y of the front wall 41. In the front wall 41, terminal insertion holes 43 penetrating in the front-rear direction X are formed at positions being opposite to the positions where the terminal accommodation rooms 31 of the main body portion 30 are formed in the front-rear direction X. That is, there are totally twelve terminal insertion holes 43 are formed in the front wall 41. The terminal insertion holes 43 are portions communicating with the terminal accommodation rooms 31 from the outside, and male terminals that are not shown in figures and disposed inside the terminal accommodation rooms 31 as the connection targets of the female terminals 11 are insertable into the terminal insertion holes 43 from the front side X2 toward the rear side X1.

In the front wall 41 of the front retainer 40, a positioning hole 44 penetrating in the front-rear direction X is formed between the portion where the two segments of the terminal accommodation rooms 31 at the upper side Z1 are formed and the portion where the two segments of the terminal accommodation rooms 31 at the lower side Z2 are formed. This positioning hole 44 is a portion into which the restricting protrusion 62 of the jig 2 is inserted, similar to the above-described positioning hole 33 of the main body portion 30. The positioning hole 44 together with the positioning hole 33 and the restricting protrusion 62 determine the position of the housing 20 in the width direction Y and the height direction Z inside the jig 2. The claw-shaped guide protrusions 45 protruding inwardly in the width direction Y are formed in the end portions at the rear side X1 of the side walls 42 of the front retainer 40, respectively.

The guide protrusions 45 are inserted from the openings of the above-described guide grooves 34 at the lower side Z2 toward the upper side Z1 to be slidingly movable in the height direction Z. Accordingly, the front retainer 40 is attached to the main body portion 30 while slidingly moving to the upper side Z1, and the front retainer 40 is detached from the main body portion 30 while slidingly moving to the lower side Z2. In this manner, the front retainer 40 is attachable to and detachable from the main body portion 30 along the height direction Z. In the two side walls 42 of the front retainer 40, fitting grooves 46 being concave inwardly in the width direction Y are formed respectively. The fitting groove 46 is a portion configured to fit with the positioning rib 63 within the width of the fitting concave portion 37 at the time when the main body portion 30 is fitted to the jig 2. The fitting groove 46 is concave in the protruding direction of the positioning rib 63 and formed at any position within the width of the fitting concave portion 37 (that is, in a range between the upper end and the lower end of the fitting concave portion 37) so as to correspond to the positioning rib 63.

The side retainer 50 is a retaining member to perform the prevention of slipping of the female terminal 11 inserted into the terminal accommodation room 31 and the like, and is attachable to and detachable from the attachment portion 35 of the main body portion 30. The side retainer 50 is positioned inside the attachment portion 35, and is connected to the main body portion 30 to be displaceable to a regular retaining position at the upper side Z1 and a temporarily retaining position at the lower side Z2 (that is, it is displaceable in the height direction Z). As shown in FIG. 3, the side retainer 50 includes a main body 51 in a rectangular box shape, and side arms (arm portion) 52 provided at two ends in the width direction Y of the main body 51. A temporarily accommodation room 53 communicating with the terminal accommodation room 31 in the state in which the side retainer 50 is attached to the attachment portion 35 is formed in the main body 51. As shown in FIG. 8A, a central axis of the temporarily accommodation room 53 extending in the front-rear direction X is biased to the upper side Z1 with respect to the central axis of the terminal accommodation room 31 extending in the same direction in the state in which the side retainer 50 is at the regular retaining position.

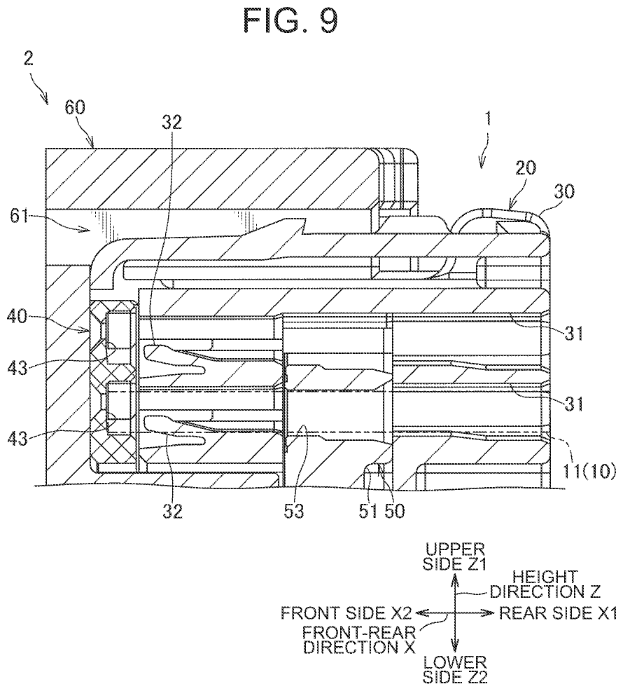

In this state, even inserting the female terminal 11 into the terminal accommodation room 31, in the portion where the side retainer 50 is positioned, the female terminal 11 is in contact with the outer wall surface or the like of the side retainer 50 such that the insertion is not completed. Also, in the state in which the female terminal 11 has already been inserted into the terminal accommodation room 31 and the temporarily accommodation room 53, the lower wall of the side retainer 50 pushes the female terminal 11 upwardly to function as a retainer to prevent the slipping. That is, in the state in which the side retainer 50 is at the regular retaining position, the insertion and removement of the female terminal 11 with respect to the terminal accommodation room 31 is restricted. On the other hand, as shown in FIG. 8B and FIG. 9, in the state in which the side retainer 50 is at the temporarily retaining position, the central axis of the temporarily accommodation room 53 extending in the front-rear direction X is substantially coaxial with the central axis of the terminal accommodation room 31 extending in the same direction. Accordingly, even inserting the female terminal 11 into the terminal accommodation room 31, there is not a case in which the female terminal 11 comes into contact with the outer wall surface or the like of the side retainer 50 such that it is possible to insert or remove the female terminal 11 with respect to the terminal accommodation room 31 in the front-rear direction X. That is, in the state in which the side retainer 50 is at the temporarily retaining position, it is possible to insert the female terminal 11 into the terminal accommodation room 31 and remove the female terminal 11 from the terminal accommodation room 31.

As shown in FIG. 3, the side arms 52 are provided at two sides in the width direction Y of the main body 51 respectively. That is, the side arms 52 are arranged at the outside of the width direction Y in the housing 20. The side arms 52 include connection portions 54 extending outwardly in the width direction Y from two side walls in the width direction Y of the main body 51, and plate-shaped cover portions 55 continuing with the connection portions 54 to extend in the front-rear direction X and the height direction Z. The connection portions 54 extends in the width direction Y to connect the main body 51 and the cover portions 55. The cover portions 55 are formed in a flat plate shape so as to cover the portion at the lower side Z2 in the two side walls in the width direction Y of the main body portion 30 when the side retainer 50 is attached to the attachment portion 35.

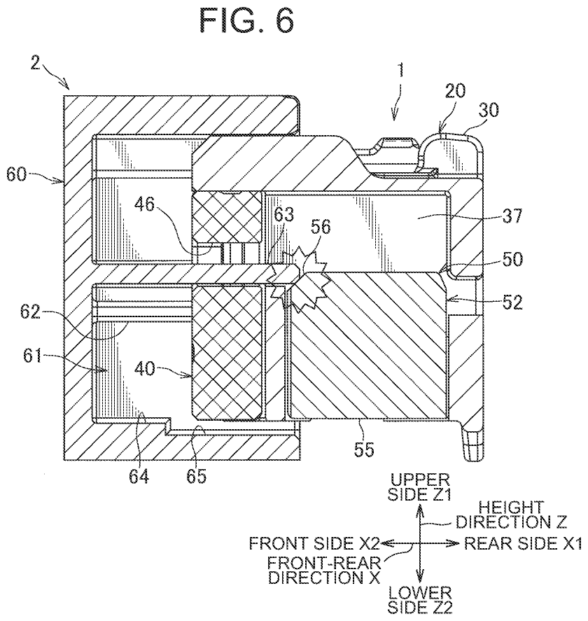

A retained portion that is not shown in figures is formed on a wall surface at the inside of the width direction Y of the cover portion 55, and this retained portion is retained to the retaining protrusion 36 of the main body portion 30 when the side retainer 50 is attached to the attachment portion 35. Due to this retaining, the side retainer 50 is connected to the main body portion 30 to be displaceable to the regular retaining position and the temporarily retaining position. A guide surface 56 is formed in the portion connecting a front edge and an upper edge of the cover portion 55. As shown in FIG. 6, the guide surface 56 is a surface being sliding contactable with the rear-end portion of the positioning rib 63 described below in the state in which the side retainer 50 is at the regular retaining position. The guide surface 56 is configured by an inclined surface that is inclined so as to be positioned at the rear side X1 as toward the upper side Z1.

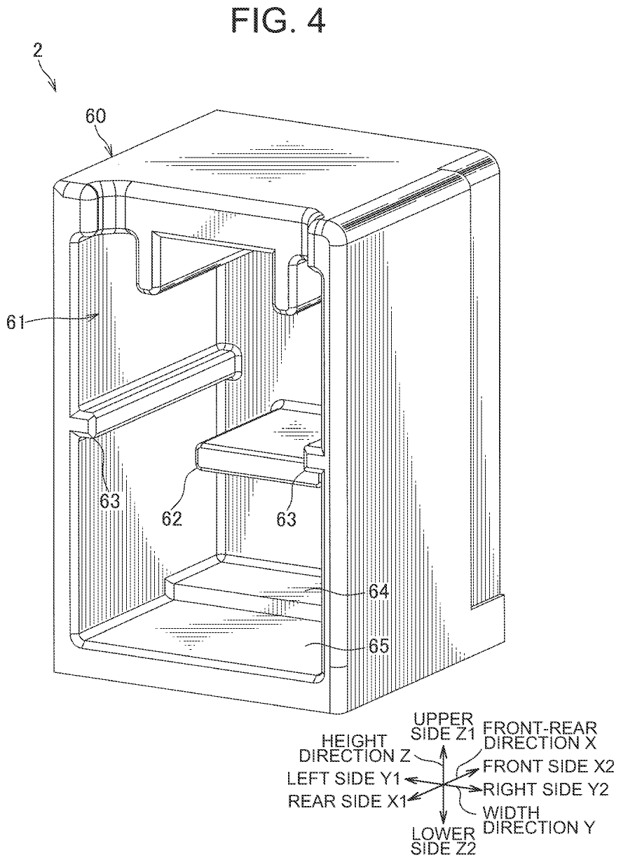

Next, the jig 2 of the connector 1 will be described. The jig 2 is a connector manufacturing apparatus that is used at the time of manufacturing the connector 1. More specifically, the jig 2 is used for determining the position of the side retainer 50. As shown in FIG. 4, the jig 2 includes a jig main body 60 that is formed in a rectangular box shape using a resin material. Inside the jig main body 60, an accommodation portion 61 is formed. The accommodation portion 61 is a portion configured to make the housing 20 of the connector 1 that is disposed at the opposite position to be fitted in the front-rear direction X, and according to the present embodiment, the accommodation portion 61 opens toward the rear side X1. The restricting protrusion 62 protruding toward the rear side X1 is formed in the central portion in the height direction Z of the front wall of the accommodation portion 61. The restricting protrusion 62 is configured by a member in a rectangular plate shape extending in the width direction Y, and the restricting protrusion 62 is insertable into the positioning hole 33 formed in the main body portion 30 of the housing 20 and the positioning hole 44 formed in the front retainer 40 that are described above.

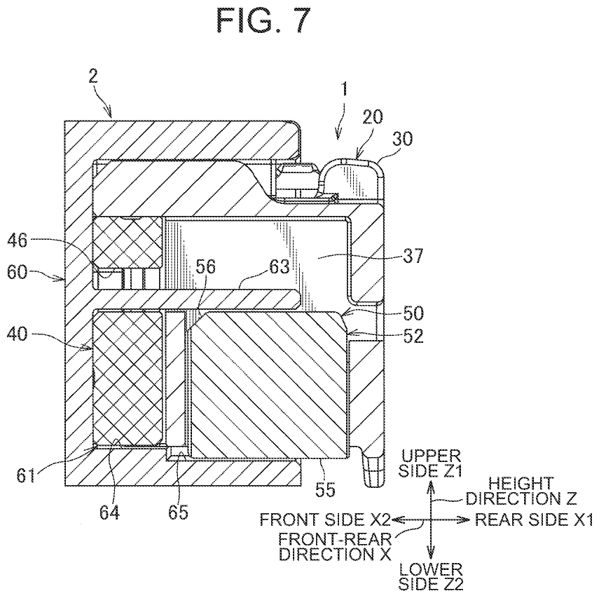

On the inner wall surface at the left side Y1 and the right side Y2 of the accommodation portion 61, positioning ribs 63 protruding toward the inside of the accommodation portion 61 in the width direction Y and extending in the front-rear direction X are formed respectively. At the time when the housing 20 is fitted to the accommodation portion 61, the positioning ribs 63 are portions being fitted to the above-described fitting grooves 46 of the front retainer 40. Also, the positioning ribs 63 are portions configured to restrict the displacement of the side retainer 50 to the height direction Z by sandwiching the side retainer 50 at the temporarily retaining position therebetween with a second lower surface 65 (inner wall surface) described below in the height direction Z. The positioning ribs 63 has a protruding end portion formed with a flat rectangular cross section, and this protruding end portion is slidingly contactable with the guide surface 56 of the side retainer 50 at the regular retaining position. Also, the protruding end portion of the positioning ribs 63, as shown in FIG. 7, is received by the fitting concave portion 37 of the main body portion 30 when the housing 20 is fitted into the accommodation portion 61.

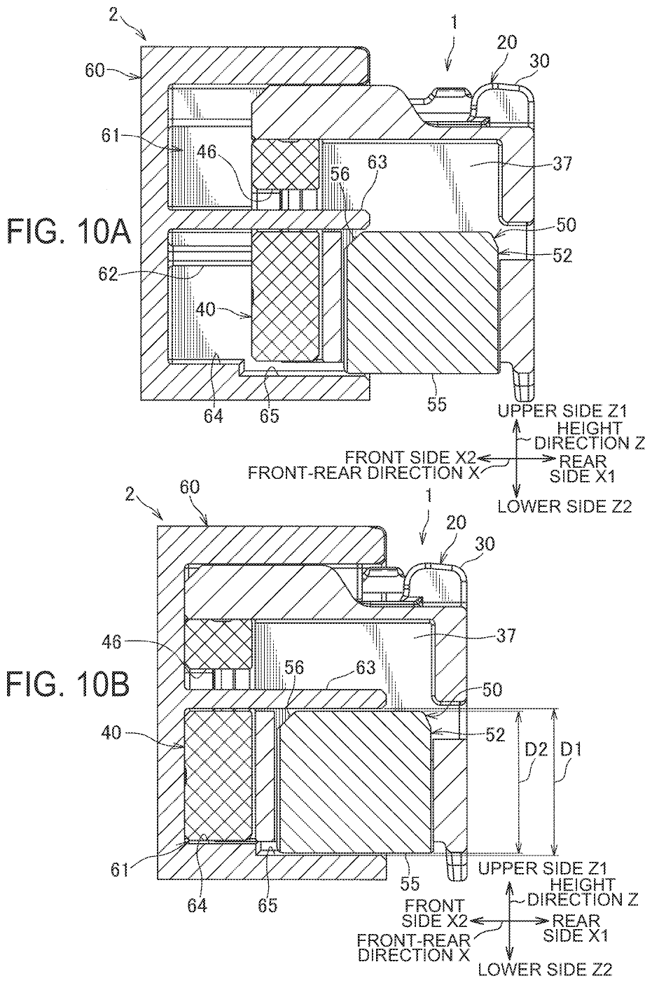

The lower wall of the accommodation portion 61 is configured by a first lower surface 64 configuring a portion at the front side X2 and a second lower surface 65 configuring a portion at the rear side X1. As shown in FIG. 7, the first lower surface 64 is in contact with the lower surface of the front retainer 40 in the housing 20 fitted to the accommodation portion 61 so as to support this portion. The second lower surface 65 is formed in steps to be positioned at the lower side Z2 further than the first lower surface 64, as shown in FIG. 7, to be in contact with the lower surface of the side retainer 50 at the temporarily retaining position to support this portion. Also, as shown in FIG. 10B, a restrict distance D1 from the lower surface of the positioning rib 63 to the second lower surface 65 is adjusted to be equal to or larger than a distance D2 from an upper end to a lower end in the side arm 52 of the side retainer 50 at the temporarily retaining position. In other words, the distance D2 from an upper end to a lower end in the side arm 52 of the side retainer 50 at the temporarily retaining position is equal to or less than the restricting distance D1.

Next, a connector manufacturing method using the jig 2 will be described. The connector manufacturing method is to position the side retainer 50 at the temporarily retaining position using the jig 2, and then in this state, to dispose the female terminal 11 in the terminal accommodation room 31 and make the female terminal 11 unable to be inserted and removed to manufacture the connector 1. The connector manufacturing method includes a preparation step, a fitting step performed after the preparation step, and an insertion step performed after the fitting step. In the preparation step, the jig 2 is disposed with the accommodation portion 61 in a posture of opening to the rear side X1, and the housing 20 is disposed such that the front retainer 40 is in opposite to the accommodation portion 61 in the front-rear direction X. At this time, as shown in FIG. 6, the front retainer 40 may be positioned at the regular retaining position, or as shown in FIG. 10A, the front retainer 40 may be positioned at the temporarily retaining position. Next, the fitting step will be performed.

In the fitting step, the housing 20 is moved to the front side X2 to be fitted to the accommodation portion 61. At this time, as the housing 20 is moved to the front side X2 inside the accommodation portion 61, outside the housing 20, the positioning ribs 63 of the jig 2 are fitted to the fitting grooves 46 of the front retainer 40. Also, at this time, in a case in which a housing does not correspond to the jig 2, such as a housing without the fitting groove 46 or the like is to be fitted to the accommodation portion 61, the positioning ribs 63 are collided with the front wall of the front retainer 40 and the like such that the fitting is restricted. That is, the positioning ribs 63 and the fitting grooves 46 also contribute to the prevention of incorrect fitting of the housing 20 and the jig 2. Also, once the positioning ribs 63 and the fitting grooves 46 are fitted with each other, the positioning ribs 63 extend to intersect with the height direction Z as the attachment/detachment direction of the front retainer 40. Accordingly, the positioning ribs 63 also contribute to restrict the front retainer 40 from displacing in the height direction Z inside the jig 2.

On the other hand, inside the housing 20, as the housing 20 is moved to the front side X2, as shown in FIG. 8A, the restricting protrusion 62 of the jig 2 is inserted into the positioning hole 44 of the front retainer 40 and the positioning hole 33 of the main body portion 30. Accordingly, the position of the housing 20 inside the jig 2 in the width direction Y and the height direction Z is determined, and the fitting of the housing 20 is performed in a more stable state. Therefore, the housing 20 is further moved to the front side X2. Here, when the front retainer 40 is positioned at the regular retaining position during the preparation step, as shown in FIG. 6, the rear-end portion (protruding end portion) of the positioning rib 63 is in contact with the side arm 52 on the guide surface 56. Hereafter, when the housing 20 is further moved to the front side X2, the side arm 52 gradually displaces to the lower side Z2 while the rear-end portion of the positioning rib 63 being sliding contact with the guide surface 56.

That is, the guide surface 56 with which the positioning rib 63 is in sliding contact is positioned further at the lower side Z2 with respect to the positioning rib 63 as the side retainer 50 is positioned further at the front side X2. Also, the side retainer 50 itself displaces to the lower side Z2 along with the displacement of the side arm 52. When the housing 20 is moved to the front side X2 until the front wall of the housing 20 comes into contact with the front wall of the accommodation portion 61, the fitting step of the housing 20 into the accommodation portion 61 is completed. In the state in which the fitting step is completed, as shown in FIG. 7, the side retainer 50 is at the temporarily retaining position. Also, the side arm 52 of the side retainer 50 is sandwiched between the second lower surface 65 of the accommodation portion 61 and the positioning rib 63 such that the displacement in the height direction Z is restricted. That is, the side retainer 50 is sandwiched in the height direction Z by the positioning rib 63 and the second lower surface 65 of the accommodation portion 61 so as to restrict the displacement in the height direction Z. Also, before the fitting step, in a case in which the side retainer 50 is positioned at the temporarily retaining position during the preparation step, as shown in FIG. 10A and FIG. 10B, the housing 20 moves to the front side X2 with the side arm 52 not being in contact with the positioning rib 63.

When the housing 20 is moved to the front side X2 until the front wall of the housing 20 is in contact with the front wall of the accommodation portion 61, the fitting step of the housing 20 to the accommodation portion 61 is completed. Then, in this state, according to FIG. 10B, the side arm 52 of the side retainer 50 is sandwiched between the second lower surface 65 of the accommodation portion 61 and the positioning rib 63 such that the displacement to the height direction Z is restricted. In this manner, according to the present embodiment, in either of the case in which the position of the side retainer 50 is at the regular retaining position and the case in which the position of the side retainer 50 is at the temporarily retaining position, by fitting the housing 20 to the jig 2, the position of the side retainer 50 is positioned at the temporarily retaining position.

In the state in which the fitting step is completed, as described above, the side retainer 50 is sandwiched in the height direction Z between the positioning rib 63 and the second lower surface 65 such that the displacement to the height direction Z is restricted. Accordingly, as shown in FIG. 9, at the inside of the housing 20, the terminal accommodation room 31 communicates with the temporarily accommodation room 53 and the central axes thereof are substantially coaxial with each other, and it is possible to insert the female terminal 11 toward the front-rear direction X. The insertion step is performed in this state. In the insertion step, the female terminal 11 is inserted from an opening terminal edge at the rear side X1 of the terminal accommodation room 31 toward the front side X2. The female terminal 11 passes through the temporarily accommodation room 53 and is subsequently inserted toward the front side X2 while making the lance 32 to be elastically deformed in the lower side Z2. Then, when the insertion of the female terminal 11 is completed, the lance 32 restores to the state before the elastic deformation to retain the female terminal 11. In this manner, the slipping of the female terminal 11 in the front-rear direction X is prevented.

Furthermore, in this state, the jig 2 is removed from the housing 20 and the side retainer 50 at the temporarily retaining position is displaced to the regular retaining position. In this manner, the female terminal 11 is pushed upwardly by the lower surface of the temporarily accommodation room 53 and thus the slipping to the front-rear direction X is further prevented. That is, the female terminal 11 is doubly retained by the lance 32 and the side retainer 50. Accordingly, the insertion step is completed.

According to the above-described embodiment, by fitting the housing 20 of the connector 1 with the accommodation portion 61 of the jig 2, it is possible to make the side retainer 50 positioned at either of the regular retaining position and the temporarily retaining position to be positioned at the temporarily retaining position. Then, at this time, since the side retainer 50 is sandwiched by the positioning rib 63 and the second lower surface 65 in the height direction Z such that the displacement in the height direction Z is restricted, it is possible to prevent the side retainer 50 positioned at the temporarily retaining position from unintentionally displacing to be positioned at the regular retaining position. Accordingly, for example, even in a case in which the connector 1 is shipped in the state of positioning the side retainer 50 at the temporarily retaining position, and the side retainer 50 unintentionally displaces to the regular retaining position to lead to a situation in which the female terminal 11 cannot be inserted into the housing 20, it is unnecessary for the operator to directly touch the side retainer 50 for repairing. That is, by fitting the housing 20 into the jig 2 only, it is possible to make the side retainer 50 to displace from the regular retaining position to the temporarily retaining position. Also, it is possible to insert the female terminal (terminal) 11 with respect to the housing 20 in the state in which the displacement of the side retainer 50 to the regular retaining position is restricted. Also, since it is possible to position the side retainer 50 at the temporarily retaining position by a simple operation of fitting the housing 20 to the jig 2, it is possible to suppress the variation in the operation accuracy due to the skill level of the operator and the instability of the posture of the side retainer 50. Accordingly, it is possible to achieve the connector 1 configured to be able to stably maintain the state in which the female terminal 11 is correctly inserted into the housing 20.

Also, the guide surface 56 can be formed in the side arm 52 of the side retainer 50 such that it is unnecessary to further provide a member or the like having a surface equivalent to the guide surface 56 in the side retainer 50 and it is possible to simplify the structure of the side retainer 50.

According to the present configuration, the side arms 52 and the positioning ribs 63 are provided at two sides in the width direction Y. Accordingly, it is possible to make the side arms 52 provided at two sides in the width direction Y of the housing 20 to be in contact with the positioning ribs 63 provided at two sides in the width direction Y of the accommodation portion 61 so as to displace the side retainer 50 to the temporarily retaining position. Also, due to the positioning ribs 63 at the two sides of the width direction Y, it is possible to restrict the displacement of the side retainer 50 positioned at the temporarily retaining position. Accordingly, by preventing the force applied to the side retainer 50 from biasing to one side of the width direction Y, it is possible to prevent the posture of the side retainer 50 during the displacement from becoming unstable, prevent the side retainer 50 positioned at the temporarily retaining position from unintentionally tilting and the like.

Also, according to the present configuration, the distance D2 from the upper end to the lower end in the side arm 52 of the side retainer 50 at the temporarily retaining position is set to be equal to or less than the restrict distance D1 from the lower surface of the positioning rib 63 to the second lower surface 65. Accordingly, at the time of performing the fitting step, in the state of making the side retainer 50 to be at the temporarily retaining position, it is possible to definitely dispose the side retainer 50 between the positioning rib 63 and the second lower surface 65. In this manner, it is possible to improve the operability of the jig 2.

Also, due to the housing manufacturing method, by performing the simple steps such as the preparation step, the fitting step, and the insertion step, it is possible to insert the female terminal 11 into the housing 20 in the state of making the side retainer 50 to be at the temporarily retaining position and restricting the displacement thereof to the height direction Z.

Although one embodiment of the present invention has been described above in detail with reference to the drawings, the specific structure is not limited to these embodiments, and design changes and the like being made without departing from the light of the present invention should also be included in the present invention. For example, according to the above-described embodiment, the connector 1 is configured as the female connector, and the terminal inserted into the housing 20 is configured as the female terminal 11, however, this configuration is no more than an example such that the connector 1 may be a male connector and the terminal may be a male terminal.

### REFERENCE SIGNS LIST

X front-rear direction (predetermined direction)
X1 rear side (one side of predetermined direction)
X2 front side (other side of predetermined direction)
Y width direction
Z height direction
Z1 upper side (one side of height direction)
Z2 lower side (other side of height direction)
1 connector
2 jig (connector manufacturing apparatus)
20 housing
50 side retainer (retaining member)
56 guide surface
61 accommodation portion
63 positioning rib
65 second lower surface (inner wall surface)

What is claimed is:

1. A connector comprising a housing fitting to an accommodation portion of a connector manufacturing apparatus,
wherein the connector manufacturing apparatus includes
the accommodation portion opening at one side in a predetermined direction, and
a positioning rib that protrudes inwardly in a width direction intersecting with the predetermined direction and extends in the predetermined direction inside the accommodation portion,
a retaining member is provided in the housing to be displaceable to a regular retaining position at one side in a height direction intersecting with the predetermined direction and the width direction and a temporarily retaining position at the other side in the height direction,
a guide surface provided in the retaining member to be slidingly contactable with the positioning rib in a state in which the retaining member is at the regular retaining position,
the guide surface being in slidingly contact with the positioning rib is positioned further at the other side of the height direction with respect to the positioning rib as the retaining member is positioned further at the other side of the predetermined direction, and
in a state in which the fitting of the housing to the accommodation portion has been completed, the retaining member is positioned at the temporarily retaining position while the retaining member is sandwiched by the positioning rib and an inner wall surface of the accommodation portion in the height direction so as to restrict a displacement to the height direction.

2. The connector according to claim 1,
wherein the retaining member includes an arm portion provided to be attachable to and detachable from the housing while being positioned at an outside in the width direction of the housing, and
the guide surface is an inclined surface provided in the arm portion while being positioned further at the one side of the predetermined direction as toward the one side of the height direction.

3. The connector according to claim 2,
wherein the positioning rib is provided at two sides of the width direction inside the accommodation portion, and
the arm portion is provided at two sides of the width direction of the housing.

4. The connector according to claim 3, wherein a distance from an end portion at the one side of the height direction to an end portion at the other side of the height direction in the arm portion of the retaining member at the temporarily retaining position is equal to or less than a distance from a lower surface as an end portion at the other side of the height direction of the positioning rib to an inner wall surface at the other side of the height direction of the accommodation portion.

5. A connector manufacturing apparatus, comprising:
an accommodation portion that opens at one side of a predetermined direction intersecting with a height direction so as to cause a housing having a retaining member being displaceable to a regular retaining position at one side of the height direction and a temporarily retaining position at the other side of the height direction to be fitted thereto,
wherein a positioning rib protruding inwardly in a width direction interesting with the predetermined direction and extend in the predetermined direction is provided in the accommodation portion,
the positioning rib is slidingly contactable with a guide surface provided in the retaining member in a case in which the retaining member is at the regular retaining position,
the positioning rib being in slidingly contact with the guide surface is positioned at further the one side of the height direction with respect to the guide surface as the retaining member is positioned at further the other side of the predetermined direction, and
in a state in which the fitting of the housing to the accommodation portion has been completed, the positioning rib and an inner wall surface of the accommodation portion sandwich the retaining member positioned at the temporarily retaining position therebetween in the height direction so as to restrict the retaining member from displacing to the one side of the height direction.

6. A connector manufacturing method for manufacturing a connector using the connector manufacturing apparatus according to claim 1, comprising:
a preparation step of making the housing to be opposite with respect to the accommodation portion in the predetermined direction;
a fitting step, subsequent to the preparation step, of fitting the housing to the accommodation portion to position the retaining member at the temporarily retaining position and sandwich the retaining member at the height direction by the positioning rib and an inner wall surface of the accommodation portion so as to restrict a displacement to the height direction; and
an insertion step, subsequent to the fitting step, of inserting a terminal into the housing,
wherein in a case in which the retaining member is at the regular retaining position during the preparation step, in the fitting step, as the retaining member displaces to the other side of the predetermined direction, the guide surface is displaced to the temporarily retaining position while being in slidingly contact with the positioning rib.
